(19) United States
(12) Patent Application Publication
(10) Pub. No.: US 2024/0412247 A1
(43) Pub. Date: Dec. 12, 2024

(54) METHOD, SYSTEM, AND NON-TRANSITORY COMPUTER READABLE RECORDING MEDIUM FOR PROVIDING INFORMATION ABOUT ADVERTISING CAMPAIGN

(71) Applicant: ADRIEL INC., Seoul (KR)

(72) Inventors: Soo Won EOM, Seoul (KR); Olivier DUCHENNE, Seoul (KR)

(21) Appl. No.: 18/694,933

(22) PCT Filed: Sep. 23, 2022
(86) PCT No.: PCT/KR2022/014245

§ 371 Date: Jul. 23, 2024

(30) Foreign Application Priority Data
Sep. 24, 2021 (KR) 10-2021-0126389

(51) Int. Cl. G06Q 30/0242

(52) U.S. Cl. CPC G06Q 30/0243

(57) ABSTRACT

A method for providing information on an advertising campaign is provided. The method includes the steps of: acquiring data associated with a campaign executed on at least one medium; and classifying and visualizing data that a user selects from the acquired data by medium or by campaign.

### FIELD OF THE INVENTION

The present invention relates to a method, system, and non-transitory computer-readable recording medium for providing information on an advertising campaign.

### BACKGROUND

As digital marketing has emerged in recent years as an important factor in driving company or brand growth, a significant part of a company's marketing efforts have been focused on the digital marketing.

The digital marketing is typically distributed across multiple media (or channels) and involves the collaboration of multiple stakeholders related to the digital marketing (e.g., marketing practitioners, executives, and agencies) to achieve targeted marketing outcomes.

However, in the past, there has been no solution that can integrally monitor data associated with digital marketing conducted across multiple media and share the data associated with the digital marketing among multiple stakeholders in real time, so that unnecessary resources are often invested in the process of conducting the digital marketing, resulting in a problem of reduced advertising efficiency and performance.

### SUMMARY OF THE INVENTION

One object of the present invention is to solve all the above-described problems in the prior art.

Another object of the invention is to integrally monitor data associated with digital marketing conducted across multiple media, so that the resources invested in managing the digital marketing are reduced and the efficiency of the digital marketing is maximized.

Yet another object of the invention is to share data associated with digital marketing among multiple stakeholders related to the digital marketing in real time, so that common goals may be achieved through transparent data management and seamless communication.

The representative configurations of the invention to achieve the above objects are described below.

According to one aspect of the invention, there is provided a method for providing information on an advertising campaign, the method comprising the steps of: acquiring data associated with a campaign executed on at least one medium; and classifying and visualizing data that a user selects from the acquired data by medium or by campaign.

According to another aspect of the invention, there is provided a system for providing information on an advertising campaign, the system comprising: a data acquisition unit configured to acquire data associated with a campaign executed on at least one medium; and a visualization management unit configured to classify and visualize data that a user selects from the acquired data by medium or by campaign.

In addition, there are further provided other methods and systems to implement the invention, as well as non-transitory computer-readable recording media having stored thereon computer programs for executing the methods.

According to the invention, it is possible to integrally monitor data associated with digital marketing conducted across multiple media, so that the resources invested in managing the digital marketing are reduced and the efficiency of the digital marketing is maximized.

According to the invention, it is possible to share data associated with digital marketing among multiple stakeholders related to the digital marketing in real time, so that common goals may be achieved through transparent data management and seamless communication.

### BRIEF DESCRIPTION OF THE DRAWINGS

FIG. 1 schematically shows the configuration of an entire system for providing information on an advertising campaign according to one embodiment of the invention.

FIG. 2 specifically shows the internal configuration of an advertising campaign information provision system according to one embodiment of the invention.

FIG. 3 illustratively shows data visualized according to one embodiment of the invention.

FIG. 4 illustratively shows data visualized according to one embodiment of the invention.

FIG. 5 illustratively shows data visualized according to one embodiment of the invention.

FIG. 6 illustratively shows a screen provided by a dashboard to edit data associated with a campaign according to one embodiment of the invention.

FIG. 7 illustratively shows a screen provided by a dashboard to share the dashboard according to one embodiment of the invention.

### DETAILED DESCRIPTION OF THE PREFERRED EMBODIMENTS

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

### Configuration of the Entire System

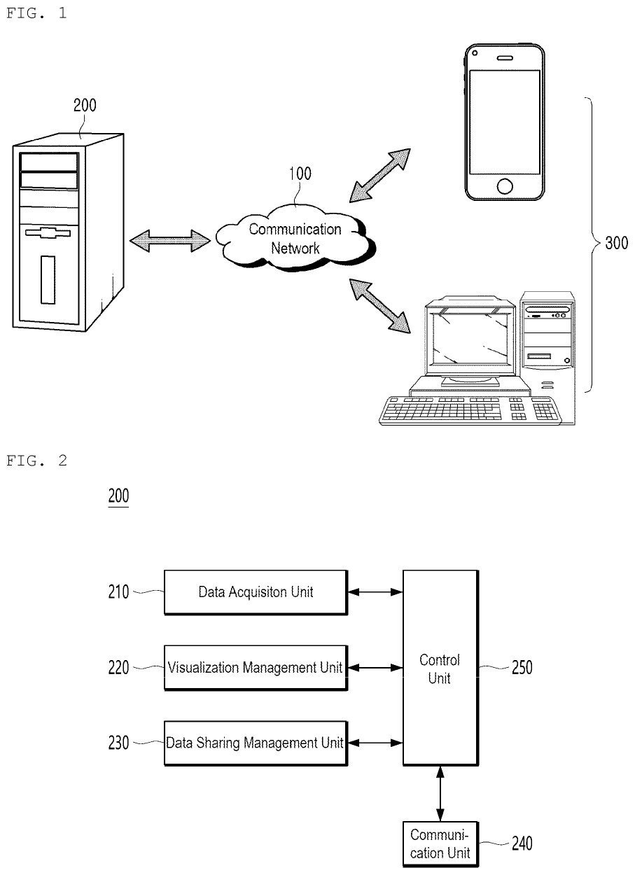

FIG. 1 schematically shows the configuration of the entire system for providing information on an advertising campaign according to one embodiment of the invention.

As shown in FIG. 1, the entire system according to one embodiment of the invention may comprise a communication network 100, an advertising campaign information provision system 200, and a device 300.

First, the communication network 100 according to one embodiment of the invention may be implemented regardless of communication modality as wired wireless such and communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

Next, the advertising campaign information provision system 200 according to one embodiment of the invention may function to acquire data associated with a campaign executed on at least one medium, and classify and visualize data that a user selects from the acquired data by medium or by campaign.

The configuration and functions of the advertising campaign information provision system 200 according to one embodiment of the invention will be discussed in detail below.

Next, the device 300 according to one embodiment of the invention is digital equipment capable of connecting to and then communicating with the advertising campaign information provision system 200, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDAs), a web pad, and a mobile phone, may be adopted as the device 300 according to the invention.

Further, according to one embodiment of the invention, the device 300 may further include an application program for performing the functions according to the invention. The application may reside in the device 300 in the form of a program module. The characteristics of the program module may be generally similar to those of a data acquisition unit 210, a visualization management unit 220, a data sharing management unit 230, a communication unit 240, and a control unit 250 of the advertising campaign information provision system 200 to be described below. Here, at least a part of the application may be replaced with a hardware device or a firmware device that may perform a substantially equal or equivalent function, as necessary.

### Configuration of the Advertising Campaign Information Provision System

Hereinafter, the internal configuration of the advertising campaign information provision system 200 crucial for implementing the invention and the functions of the respective components thereof will be discussed.

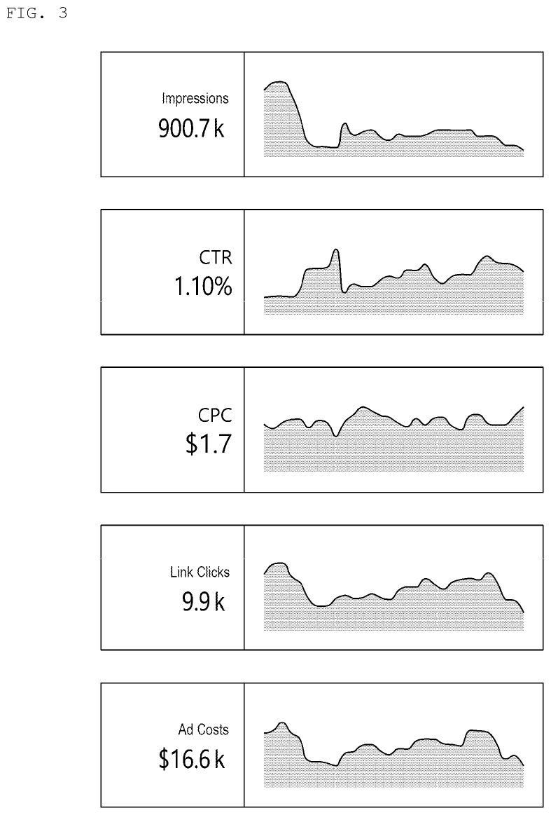

FIG. 2 specifically shows the internal configuration of the advertising campaign information provision system 200 according to one embodiment of the invention.

As shown in FIG. 2, the advertising campaign information provision system 200 according to one embodiment of the invention may comprise a data acquisition unit 210, a visualization management unit 220, a data sharing management unit 230, a communication unit 240, and a control unit 250. According to one embodiment of the invention, at least some of the data acquisition unit 210, the visualization management unit 220, the data sharing management unit 230, the communication unit 240, and the control unit 250 of the advertising campaign information provision system 200 may be program modules to communicate with an external system (not shown). The program modules may be included in the advertising campaign information provision system 200 in the form of operating systems, application program modules, or other program modules, while they may be physically stored in a variety of commonly known storage devices. Further, the program modules may also be stored in a remote storage device that may communicate with the advertising campaign information provision system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the advertising campaign information provision system 200 has been described as above, and it will be apparent to those skilled in the art that at least a part of the components or functions of the advertising campaign information provision system 200 may be implemented in the device 300 or a server (not shown) or included in an external system (not shown), as necessary.

First, the data acquisition unit 210 according to one embodiment of the invention may function to acquire data associated with a campaign executed on at least one medium.

Here, the medium according to one embodiment of the invention refers to a website or platform on the Internet where digital marketing may be conducted, such as Google, Facebook, Instagram, YouTube, Twitter, Kakao, and Naver. However, the medium according to one embodiment of the invention is not necessarily limited to those listed above, and may include any medium where digital marketing may be conducted.

Further, the campaign according to one embodiment of the invention refers to a means for conducting digital marketing, such as an act of delivering a series of information to the public with the aim of promoting sales of goods, increasing utilization of services, or the like. For example, the campaign according to one embodiment of the invention may include various types of campaigns such as search campaigns, display campaigns, video campaigns, shopping campaigns, and app campaigns.

Next, according to one embodiment of the invention, the data acquisition unit 210 may interwork with the at least one medium, and may acquire data associated with a campaign executed on the at least one interworking medium. More specifically, the data acquisition unit 210 according to one embodiment of the invention may utilize an open API, a scraping technique, or the like to acquire data associated with a campaign executed on the at least one interworking medium.

Here, according to one embodiment of the invention, the data associated with the campaign executed on the at least one medium and acquired by the data acquisition unit 210 may include data on at least one of status (e.g., whether the campaign is active or inactive), advertising costs, budgets, performance (e.g., return on ad spend (ROAS), click-through rate (CTR), impressions, link clicks, cost per click (CPC), or cost per mille (CPM)), and materials (e.g., text, images, or audio included in the campaign) of the campaign executed on the at least one medium.

Next, the visualization management unit 220 according to one embodiment of the invention may function to classify and visualize, by medium or by campaign, data that a user selects from the data associated with the campaign executed on the at least one medium and acquired by the data acquisition unit 210.

According to one embodiment of the invention, the data associated with the campaign executed on the at least one medium and acquired by the data acquisition unit 210 may be selected by the user according to the user's purpose of utilizing the data. For example, if a user wishes to determine the performance of a campaign and discontinue the execution of a campaign that is not performing well, the data on the performance may be selected by the user from the data associated with the campaign executed on the at least one medium. As another example, if a user wishes to increase the advertising efficiency of a campaign by changing the materials of the campaign, the data on the materials may be selected by the user from the data associated with the campaign executed on the at least one medium.

Next, the visualization management unit 220 according to one embodiment of the invention may classify (or categorize or group) the data selected by the user with reference to a predetermined criterion, and may generate data on comparison between two or more campaigns specified from the classified data. Here, the predetermined criterion for classifying the data selected by the user according to one embodiment of the invention may relate to the medium itself where the campaign is executed or the campaign itself, and may include, for example, the type of the medium where the campaign is executed, the target audience of the and the date of execution of the campaign. campaign, However, the predetermined criterion for classifying the data selected by the user according to one embodiment of the invention is not necessarily limited to those listed above, and may be changed without limitation as long as the objects of the invention may be achieved.

Meanwhile, according to one embodiment of the invention, the two or more campaigns for generating the comparison data may be specified on the basis of inputs from the user (i.e., manual inputs), and may also be specified on the basis of context information on the user in addition to the inputs from the user. For example, according to one embodiment of the invention, the two or more campaigns may be specified with reference to a database built on the basis of information on previous inputs from the user (or other users), or output results of a learning model trained on the basis of information on previous inputs from the user (or other users).

Meanwhile, the visualization management unit 220 according to one embodiment of the invention may also generate alarm data on the basis of the data associated with the campaign executed on the at least one medium and acquired by the data acquisition unit 210. More specifically, the visualization management unit 220 according to one embodiment of the invention may generate the alarm data in response to the data associated with the campaign executed on the at least one medium meeting a predetermined alarm generation condition. For example, if the total advertising costs of the campaign executed on the at least one medium exceed a predetermined level, the visualization management unit 220 according to one embodiment of the invention may generate alarm data indicating that the advertising costs exceed the predetermined level.

Next, the visualization management unit 220 according to one embodiment of the invention may visualize the above data (i.e., the classified data, the comparison data, or the alarm data) using graphical elements. Specifically, the visualization management unit 220 according to one embodiment of the invention may determine a graphical element corresponding to each characteristic of the above data, and visualize the above data using the determined graphical element. Here, according to one embodiment of the invention, the graphical elements used to visualize the data may include at least one of text, images, tables, graphs, and pop-ups. Meanwhile, it is noted that the data generated or visualized by the visualization management unit 220 according to one embodiment of the invention is not necessarily limited only to the classified data, the comparison data, or the alarm data, and various types of data may be generated or visualized by the visualization management unit 220 as long as the objects of the invention may be achieved.

Next, the visualization management unit 220 according to one embodiment of the invention may arrange the visualized data on a dashboard. More specifically, the visualization management unit 220 according to one embodiment of the invention may arrange the visualized data on a dashboard using a widget. Here, according to one embodiment of the invention, the data contained in the widget (i.e., the visualized data) may be customized for each user on the basis of inputs from the user (i.e., manual inputs). For example, according to one embodiment of the invention, data visualized in a table format may be reconstructed into a pivot table customized for each user on the basis of inputs from the user. Meanwhile, according to one embodiment of the invention, the data contained in the widget may be customized for each user on the basis of context information on the user as well as inputs from the user. For example, according to one embodiment of the invention, the data may be customized with reference to a database built on the basis of information on previous inputs from the user (or other users), or output results of a learning model trained on the basis of information on previous inputs from the user (or other users).

Next, according to one embodiment of the invention, the user may edit the data associated with the campaign executed on the at least one medium via the dashboard (or the data arranged on the dashboard). More specifically, according to one embodiment of the invention, the user may view and edit the budgets, materials, and the like of the campaign executed on the at least one medium via the dashboard in real time. For example, according to one embodiment of the invention, the user may perform editing such as switching a material of the campaign executed on the at least one medium to active or inactive, or changing the material to a different material via the dashboard. Here, according to one embodiment of the invention, the user may edit the materials of the campaign using a content (e.g., text, images, or audio) that the user personally possesses, or using at least one of a plurality of contents (e.g., text, images, or audio) provided (or recommended) by the dashboard.

Next, the data sharing management unit 230 according to one embodiment of the invention may function to cause at least a part of the data associated with the campaign executed on the at least one medium and acquired by the data acquisition unit 210 to be shared with users belonging to at least one group associated with the campaign.

Here, according to one embodiment of the invention, the group associated with the campaign executed on the at least one medium may include at least one of members of an organization or team executing the campaign and stakeholders associated with the campaign (wherein the members of the organization or team executing the campaign may be described as being included in the stakeholders associated with the campaign). For example, the group associated with the campaign may include marketing practitioners in a marketing organization (or team) of a company, executives of the company, and agencies providing management or agency services for the campaign.

Next, according to one embodiment of the invention, at least a part of the data associated with the campaign executed on the at least one medium and acquired by the data acquisition unit 210 may be visualized by the visualization management unit 220, and the data sharing management unit 230 may cause the visualized data to be shared with users belonging to the group associated with the campaign via a dashboard.

More specifically, the data sharing management unit 230 according to one embodiment of the invention may cause the same dashboard to be shared by each group associated with the campaign. Here, according to one embodiment of the invention, the dashboard shared by one group associated with the campaign may be shared in the same appearance with all users belonging to that group in real time. That is, according to one embodiment of the invention, all users belonging to one group associated with the campaign may share the data arranged on the dashboard in real time. Further, according to one embodiment of the invention, all users belonging to one group associated with the campaign may not only share the data arranged on the dashboard in real time, but also manage and analyze the shared data using a collaboration tool. Here, the collaboration tool according to one embodiment of the invention refers to a means for allowing individual users belonging to the group associated with the campaign to write comments (e.g., comments for assigning tasks to other users) in the data arranged on the dashboard, and may include, for example, notes, memos, messages, and stickers. However, the collaboration tool according to one embodiment of the invention is not necessarily limited to those listed above, and may be changed without limitation as long as the objects of the invention may be achieved. Meanwhile, according to one embodiment of the invention, access rights to the shared data may be differently set for (or granted to) the respective users. For example, the access rights may consist of administrator rights, read and edit rights, and read-only rights, so that the administrator rights may be set for company executives, the read and edit rights may be set for marketing practitioners, and the read-only rights may be set for agencies.

Meanwhile, according to one embodiment of the invention, the aforementioned functions that may be performed via the dashboard (e.g., user customization of the visualized data, and editing of the data associated with the campaign executed on the at least one medium) may also be applied when the dashboard is shared as described above. In particular, according to one embodiment of the invention, when the dashboard is shared among users belonging to a group associated with the campaign, all users belonging to the group may be provided with the same alarm data (or visualized alarm data) generated on the basis of the shared data via the dashboard, and users with administrator rights or edit rights may edit the alarm generation condition of the alarm data.

As described above, the present invention enables the data associated with the campaign executed on the at least one medium to be integrally monitored via a dashboard, so that the resources invested in managing digital marketing are reduced and the efficiency of the digital marketing is maximized.

Further, the present invention enables the dashboard to be shared in the same appearance with all users belonging to a group associated with the campaign in real-time, so that common goals may be achieved through transparent data management and seamless communication.

Next, the communication unit 240 according to one embodiment of the invention may function to enable data transmission/reception from/to the data acquisition unit 210, the visualization management unit 220, and the data sharing management unit 230.

Lastly, the control unit 250 according to one embodiment of the invention may function to control data flow among of the data acquisition unit 210, the visualization management unit 220, the data sharing management unit 230, and the communication unit 240. That is, the control unit 250 according to the invention may control data flow into/out of the advertising campaign information provision system 200 or data flow among the respective components of the advertising campaign information provision system 200, such that the data acquisition unit 210, the visualization management unit 220, the data sharing management unit 230, and the communication unit 240 may carry out their particular functions, respectively.

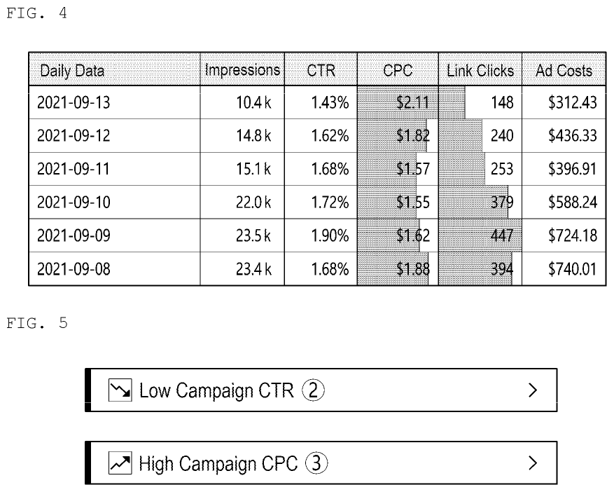

FIGS. 3 to 5 illustratively show data visualized according to one embodiment of the invention.

Referring to FIG. 3, the visualization management unit 220 according to one embodiment of the invention may classify data selected by a user (i.e., data on performance and advertising costs of a campaign executed on at least one medium) with reference to a date of execution of the campaign, and visualize the classified data using a graph (wherein the x-axis of the graph may correspond to the date of execution of the campaign).

Referring to FIG. 4, the visualization management unit 220 according to one embodiment of the invention may classify data selected by a user (i.e., data on performance and advertising costs of a campaign executed on at least one medium) with reference to a date of execution of the campaign, and visualize the classified data and comparison data using a table.

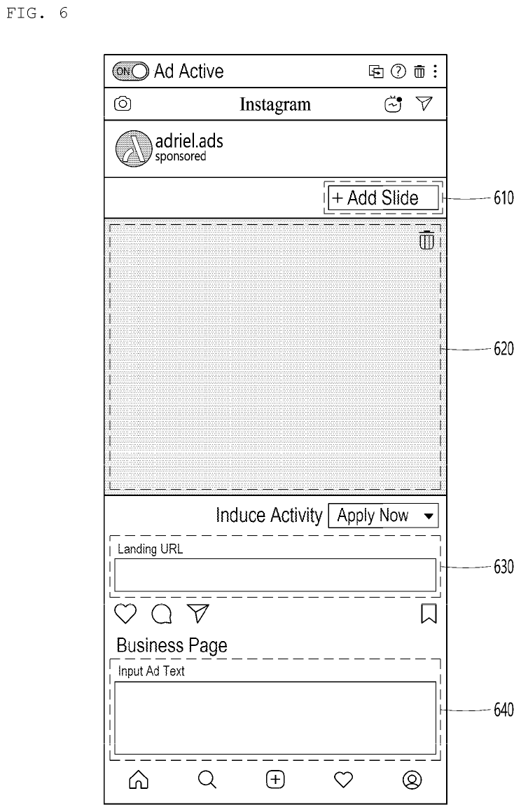

Referring to FIG. 5, the visualization management unit 220 according to one embodiment of the invention may generate alarm data on the basis of data on performance of a campaign executed on at least one medium, and visualize the generated alarm data. More specifically, the visualization management unit 220 according to one embodiment of the invention may generate alarm data indicating that a click-through rate (CTR) of a campaign executed on at least one medium is not greater than a predetermined level, and alarm data indicating that a cost per click (CPC) of the campaign executed on the at least one medium is greater than a predetermined level, and visualize the generated alarm data.

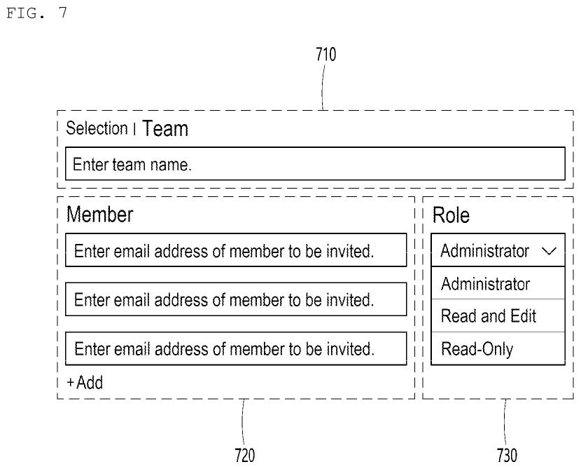

FIG. 6 illustratively shows a screen provided by a dashboard to edit data associated with a campaign according to one embodiment of the invention.

Referring to FIG. 6, a user may view or edit the materials of a campaign executed on a medium (i.e., Instagram) in real time via the dashboard, without having to directly access Instagram. More specifically, the user may add a slide to the campaign executed on Instagram (610), change an image or video included in the slide (620), change a landing URL (630), or change text (640) via the dashboard.

FIG. 7 illustratively shows a screen provided by a dashboard to share the dashboard according to one embodiment of the invention.

Referring to FIG. 7, in order to share the same dashboard among users belonging to a group associated with a campaign, a name for the group (or team name) may be set (710), users (or members) with whom the dashboard is to be shared may be determined (720), and a predetermined access right may be granted to each of the determined users (730).

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for providing information on an advertising campaign, the method comprising the steps of:
acquiring data associated with a campaign executed on at least one medium; and
classifying and visualizing data that a user selects from the acquired data by medium or by campaign.

2. The method of claim 1, wherein the data associated with the campaign executed on the at least one medium includes data on at least one of status, advertising costs, budgets, performance, and materials of the campaign executed on the at least one medium.

3. The method of claim 1, wherein the visualized data includes at least one graphical element of text, images, tables, graphs, and pop-ups.

4. The method of claim 1, wherein the visualized data is customized on the basis of inputs from the user or context information on the user.

5. The method of claim 1, wherein the user is allowed to view or edit materials of the campaign executed on the at least one medium in real time.

6. The method of claim 1, wherein the user is allowed to receive an alarm generated on the basis of the data associated with the campaign executed on the at least one medium.

7. The method of claim 1, wherein in the visualizing step, data on comparison between two or more campaigns specified on the basis of inputs from the user or context information on the user is visualized.

8. A non-transitory computer-readable recording medium having stored thereon a computer program for executing the method of claim 1.

9. A system for providing information on an advertising campaign, the system comprising:
a data acquisition unit configured to acquire data associated with a campaign executed on at least one medium; and
a visualization management unit configured to classify and visualize data that a user selects from the acquired data by medium or by campaign.

10. The system of claim 9, wherein the data associated with the campaign executed on the at least one medium includes data on at least one of status, advertising costs, budgets, performance, and materials of the campaign executed on the at least one medium.

11. The system of claim 9, wherein the visualized data includes at least one graphical element of text, images, tables, graphs, and pop-ups.

12. The system of claim 9, wherein the visualized data is customized on the basis of inputs from the user or context information on the user.

13. The system of claim 9, wherein the user is allowed to view or edit materials of the campaign executed on the at least one medium in real time.

14. The system of claim 9, wherein the user is allowed to receive an alarm generated on the basis of the data associated with the campaign executed on the at least one medium.

15. The system of claim 9, wherein the visualization management unit is configured to visualize data on comparison between two or more campaigns specified on the basis of inputs from the user or context information on the user.
